(19) United States
(12) Patent Application Publication
(10) Pub. No.: US 2010/0064358 A1
(43) Pub. Date: Mar. 11, 2010

(54) APPARATUS AND METHOD FOR MANAGING INFORMATION

(76) Inventors: Joseph M. Luna, Spring, TX (US); Gerald W. Smith, Houston, TX (US); Ernestine M. Dach, Trinity, TX (US); Hacene Benchikha, San Antonio, TX (US)

Correspondence Address: Vedder Price PC, 222 NORTH LASALLE STREET, CHICAGO, IL, 60601, US

(21) Appl. No.: 12/207,967

(22) Filed: Sep. 10, 2008

(51) Int. Cl. H04L 9/32; G06F 21/00

(52) U.S. Cl. 726/6

(57) ABSTRACT

A method and apparatus are provided for managing system identification information for workforce members such as employees, contractors and consultants that are affiliated with a business entity such as a corporation. The method and apparatus provide for the association of system identification information of a workforce member with each such workforce member in memory and further provides a review process of the same information by the relevant workforce member and one or more of the workforce member's supervisors. The review process allows each of the workforce member and the applicable supervisor(s) to confirm and, in some instances, reject the system identification information as being valid or not valid. The method and apparatus further maintains the review status of the workforce member and the applicable supervisor(s) and in one embodiment, provides for an audit of the same so that any discrepancies in the reviews are brought to light.

### FIELD OF THE INVENTION

The present disclosure generally relates to managing information, and more particularly, to managing information associated with members of a business entity's workforce.

### BACKGROUND OF THE INVENTION

Firms, enterprises and other business entities generally employ more than one employee, consultant, contractor, independent contractor or other workforce member for the purpose of providing goods or services to third parties. As such, it is known for business entities to spend significant resources managing information pertaining to and otherwise associated with its workforce. As part of this expenditure, business entities regularly utilize proprietary and/or commercial software to manage and track this information for easy recall and to ensure the integrity of these records. Information regularly tracked by business entities with respect to their workforce members includes, but is not limited to, employee identification numbers, hire dates, termination dates, dates associated with leaves of absence, employee levels and related histories, a location of employee's office, contract information, position history, enterprise identification information, other human resources information, etc.

It is also known for business entities to employ or to have under contract certain workforce members that require access to a variety of enterprise resource planning systems or other systems on different platforms, some of which are managed by third-party administrators. Examples of these systems include, but are not limited to, various business software solutions provided by SAP AG, Business Objects (an SAP company) and Oracle Corporation. Because many of these systems are hosted and managed by third parties and because these systems often have general applicability to a wide variety of business entities in the same or different market segments, system identification information is generally required as a security measure for access thereto. In general, system identification information may take any suitable form including but not limited to a user name, a password, and/or token authenticator information (e.g., as provided by RSA, the Security Division of EMC Corporation), etc. Generally, third-party administrators are responsible for the issuance, management and general administration of system identification information necessary for access to such systems. For example, a business entity may request system identification information from a third-party administrator for a particular workforce member. In response, the particular third-party administrator may be responsible for confirming the appropriateness of the request and for issuing system identification information in response thereto.

It is known that the information accessible through such systems may constitute the sensitive and/or confidential information of its owner. In some cases, the owner of such information is the business entity that employs or has under contract the applicable workforce member having access to such system(s). In other cases, the owner is a client, customer or other partner of the business entity. Regardless of the particular owner, the information generally has value and, as such, it is customary for business entities to deploy audit plans to regularly monitor permission rights of its workforce members having access to systems. While some audit plans are required by law or applicable regulations, others are a matter of statements, regulations and policies of a company or another organization (e.g., the Statement of Auditing Standards No. 70: Service Organization (also known as the SAS70), the Sarbanes Oxley Act, etc.).

For example, a consulting firm may deploy an audit plan under which an independent auditing company may be called upon a pre-determined number of times per year to confirm compliance with such plan. During each audit, the independent consulting company may, for example, contact third-party system administrators to determine the active system identification information for workforce members associated with the consulting firm. With this information, the auditing company may use the compiled active system identification information to determine whether the active system identification information should remain active based on the current status of the workforce member with the business entity. In one example, if the workforce member is no longer employed by or under contract with the business entity, the system identification information should not remain active or valid. In another example, if a workforce member is no longer part of a project that requires access to another business entity's system(s), such system identification information granting the workforce member access to such system(s) should not remain active or valid.

While the process described above is one solution for managing system identification information and other information of workforce members, it is costly from both a time and expense basis. For example, the solution requires a significant time investment of auditing companies and third-party administrators. Naturally, auditing companies and third-party administrators pass these costs through to their clients (i.e., the business entities) in the form of fees, invoices or otherwise. The above-described solution also discourages business entities from taking a proactive stance in the management of such system identification information as such business entities are afforded the opportunity to merely rely on the efforts of third-party administrators and auditing companies.

Consequently, there exists a need for a new solution for managing, reviewing, and maintaining system identification information that does not so heavily rely on the services of auditing companies and third-party administrators and that is more flexible and responsive.

### BRIEF DESCRIPTION OF THE DRAWINGS

The invention will be more readily understood in view of the following description when accompanied by the below figures and wherein like reference numerals represent like elements.

FIG. 1 illustrates a block diagram of an exemplary system for managing system identification information for workforce members;

FIG. 2 illustrates a block diagram of another exemplary system for managing system identification information for workforce members; and

FIG. 3 illustrates an exemplary flow of a computer-implemented method for managing system identification information for workforce members.

### DETAILED DESCRIPTION

A computer implemented method and related apparatus are disclosed providing for the management of system identification information (e.g., passwords and ID's, etc.) of workforce members (e.g., employees, contractors, consultants, etc.) of a business entity. The method and apparatus permits the association of system identification information of a workforce member with such workforce member in memory (e.g., a database). The association may be made using, for example, a profile for each workforce member where the profile contains the relevant system identification information. The method and apparatus also provides a review process whereby both a workforce member and a supervisor of the workforce member create review data indicating whether each has confirmed the system identification information (e.g., as being valid).

In one embodiment, the association of system identification information with a workforce member is made by a system operator of the business entity that employs or otherwise has the workforce member under contract. In another embodiment, the system operator is able to modify, delete or add the system identification information to the relevant profile (e.g., as part of an association with the workforce member). In yet another embodiment, the system operator may modify, delete or add other workforce member-related information that is applicable to human resources or that otherwise relates to the system identification information. For example, a system operator of a business entity may be charged with the responsibility of tracking or otherwise monitoring the status of system identification information requests from a third party administrator. In the event that new system identification information is requested or in the event that a workforce member requires additional access rights for the system, communication may be transmitted between the system administrator and a third party administrator. Such communications may be relevant to the business entity and therefore tracked by associating it with the applicable workforce member.

In one embodiment, the method and system provide for an audit by the business entity whereby the results of the audit indicates any discrepancies between the review data of the workforce member and the corresponding review data of the relevant supervisor. In this manner, the audit provides a check on the system identification information from at least two parties in the business entity (e.g., the workforce member and the relevant supervisor) and thereby provides integrity of the maintained data. The audit also allows a business entity the flexibility of proactively managing the system identification information assigned to its workforce members thereby simplifying or rendering an external audit unnecessary.

In the following detailed description, numerous specific details are set forth in order to provide a thorough understanding the present disclosure. It will be apparent to one of ordinary skill in the art, however, that these specific details need not be used to practice the present disclosure. In other instances, well-known structures, interfaces and processes have not been shown or described in detail in order to avoid obscuring the instant disclosure.

As used herein, the following terms have the meanings ascribed thereto as set forth below. A “peripheral device” may refer to any input device or any input/output device to a processing device and may include, but is not limited to a keyboard, a mouse, a trackpad, a stylus and associated smart display, etc. A “processing device” may refer to any number of physical devices that is/are capable of processing (e.g., performing a variety of operations on) information (e.g., information in the form of binary data or carried/represented by any suitable media, signal, etc.). For example, a processing device may be a processor capable of executing executable instructions, a desktop computer, a laptop computer, a mobile device, a hand-held device, a server (e.g., a file server, a web server, a program server or any other server), etc. or any combination of the above. An example of a processing device may be a device that includes one or more integrated circuits comprising transistors that are programmed or configured to perform a particular task. A “processor” may refer to one or more dedicated or non-dedicated: microprocessors, microcontrollers, sequencers, microsequencers, digital signal processors, digital signal processors, processing engines, hardware accelerators, application specific circuits (ASICs), state machines, programmable logic arrays, any integrated circuit(s), discrete circuit(s), etc. that is/are capable of processing data or information, and any suitable combination(s) thereof. “Memory” may refer to any suitable violate or non-volatile memory, memory device, memory chip(s), or storage device or chip(s) such as, but not limited to system memory, frame buffer memory, flash memory, random access memory (RAM), read-only memory (ROM), a register, a latch, or any combination of the above. “Executable instructions” may refer to software or firmware programs or instructions or any other suitable instructions or commands capable of being processed by a suitable processor. “Logic” may refer to any single or collection of circuits, integrated circuits, processors, transistors, memory, combination logic circuit, or any combination of the above that is capable of providing a desired operation(s) or function(s). For example, logic may take the form of a processor executing instructions from memory or a dedicated integrated circuit. A “communication link” may refer to any media through which signals, data or other information may be communicated. For example, a communication link may include one or more wires, busses, cables, infra-red signals, waveforms (e.g., a wireless path), network routers, hubs, etc., and any combination of the above. A “display device” may refer to any device or component of a device that is capable of visually reproducing visual information or data such as, but not limited to a CRT, a LCD or plasma display device.

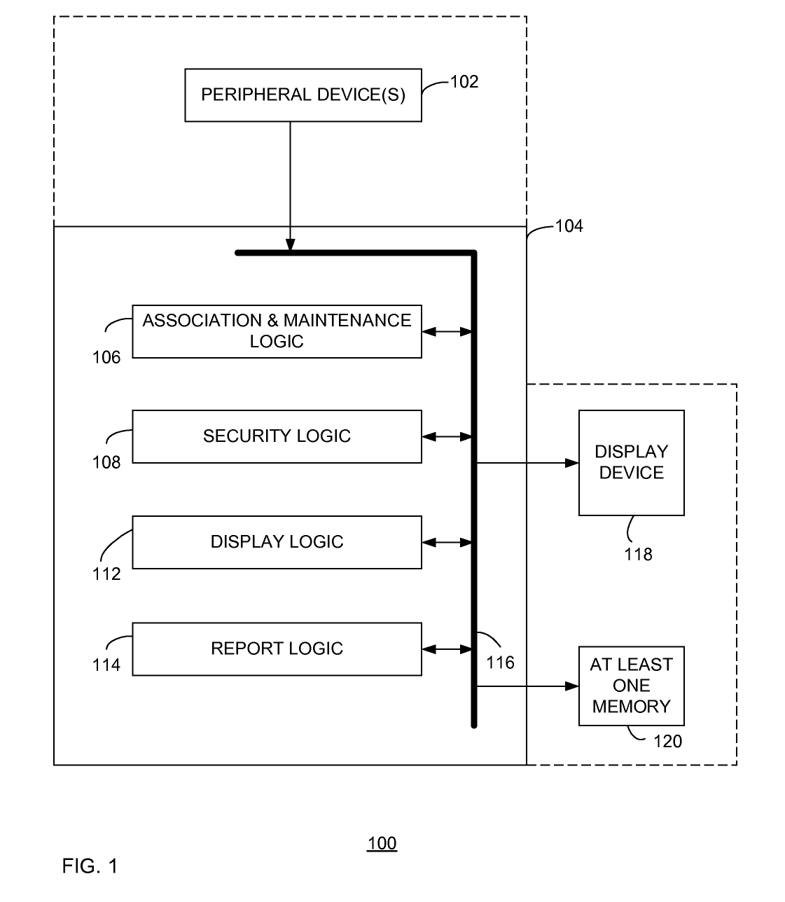

FIG. 1 illustrates a block diagram of an exemplary system 100 for managing system identification information for workforce members. Exemplary system 100 includes one or more peripheral devices 102, one or more processing devices 104, a display device 118 and at least one memory 120. Processing device 104 at least includes association and maintenance logic 106, security logic 108, display logic 112 and report logic 114. In one embodiment, as suggested by the dashed lines in FIG. 1, processing device 104 includes display device 118 and the at least one memory 120. In this embodiment, the processing device 104 may be a handheld device such as a cell phone or a mobile device such as a personal digital assistant or laptop, etc. In another embodiment, the processing device 104 is a separate device from one or more of: the display device 118 and the at least one memory 120. In this embodiment, the processing device 104 may be a traditional desktop computer. Each of the individual pieces of logic 106-114 associated with the processing device 104 are coupled to each other via communication link 116. As illustrated, peripheral device(s) 102 is coupled to the processing unit 104 via the communication link 116. Finally, the display device 118 is coupled to the processing unit 104 via the communication link 116.

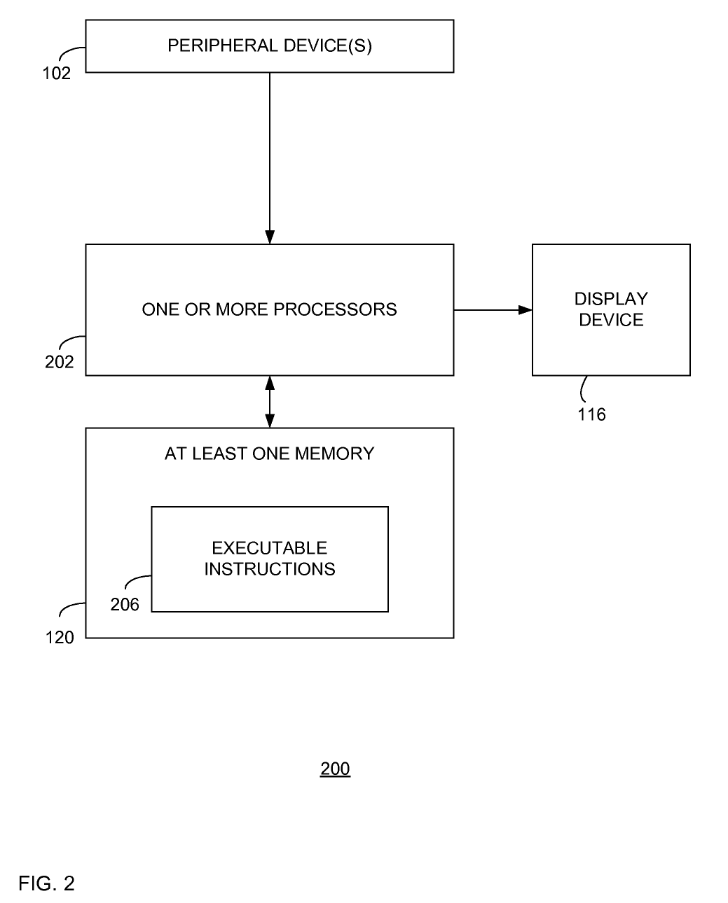

FIG. 2 illustrates a block diagram of an exemplary system 200 for managing system identification information for workforce members. System 200 includes one or more peripheral devices 102, one or more processors 202, at least one memory 120 containing executable instructions 204, and display device 118.

Each of FIG. 1 and FIG. 2 illustrate exemplary systems 100 and 200 for managing system identification information for workforce members. It is recognized that a variety of other system configurations and components, whether networked or stand-alone, may be used and adopted to manage the same. For example, a networked or distributed system containing components coupled to one another by way of the internet (or any other communications media) may be implemented to provide the same affect. Accordingly, it is recognized that the specific configurations illustrated in FIGS. 1 and 2 are meant to be illustrative and not limiting.

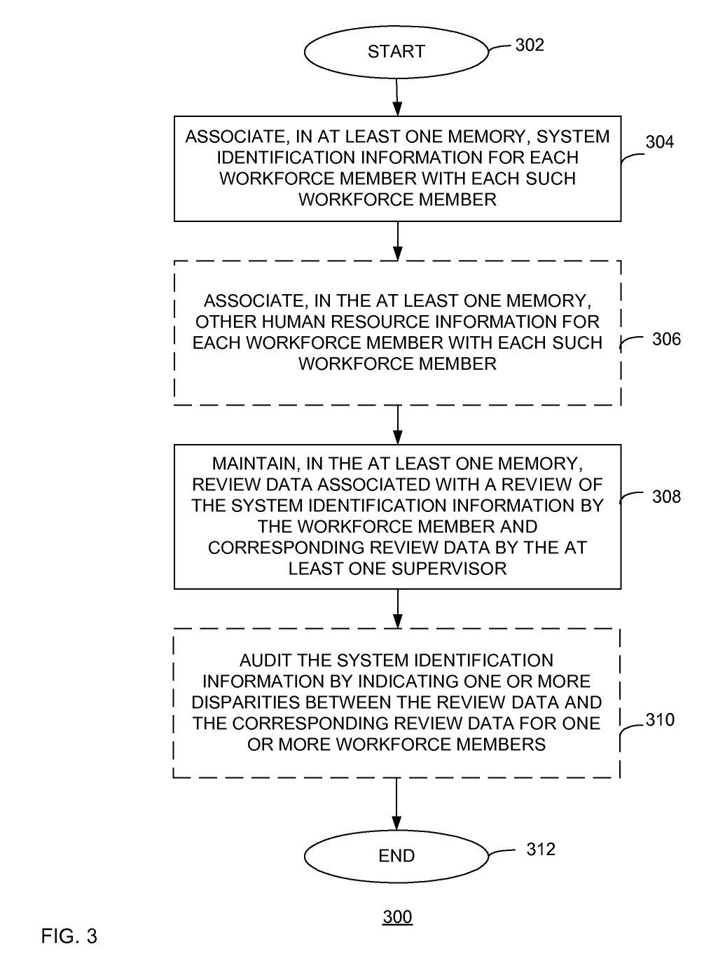

Each of system 100 and system 200 may be used by a business entity to manage system identification information and other information for its workforce members. For example, FIG. 3 illustrates an exemplary flow of a computer-implemented method 300 for managing system identification information for workforce members. The method starts in block 302 where, for example, a database or other store of information may be created or initialized to store, maintain and associate information. In one embodiment, the database or information bank may be implemented and maintained using a Microsoft SQL server. In systems 100 and 200, the database or information bank may be stored, for example, in the at least one memory 120.

The method then continues to block 304 where system identification information for each workforce member (e.g., of a business entity such as a corporation), each having at least one supervisor or boss, is associated with each such workforce member in the at least one memory. The system identification information represents information capable of being used to access one or more systems managed by a third party administrator. For example, such a system may be a system offered by Business Objects and managed (e.g., has access rights managed) by a third party (e.g. a company that does not employ or does not have under contract the workforce members) via a third party administrator.

In system 100, for example, the system identification information may be input by a system operator (e.g., a human resources employee or any other suitable person) using the one or more peripheral devices 102. In one embodiment, the system operator is a workforce member of the business entity employing or having the workforce member under contract. In system 100, the system identification information is transmitted from the one or more peripheral devices 102 to the at least one memory 120 using association and maintenance logic 106 and communication link 116. Association and maintenance logic 106 associates the applicable system identification information for each workforce member with such workforce member in the at least one memory 120 using any suitable association scheme as is known in the art. For example, in one embodiment, association and maintenance logic 106 creates a unique workforce member profile in the at least one memory 120 for system identification information to be stored and associated therewith.

In one embodiment, method block 304 includes the method of confirming the credentials of a system operator to modify, delete or add system identification information and/or other workforce member-related information for one or more workforce members. Such other workforce member-related information may include for example: employee identification numbers, hire date(s), termination date(s), dates associated with leaves of absence, employee levels and related histories, a location of employee's office, contract information, position history, enterprise identification information, other human resource information, etc. In one embodiment, the other workforce member-related information may include information that was previously transmitted to or from a third party administrator (e.g., of a system to which the system identification information provides access) and generally represents an attribute of a workforce members' system identification information. The attribute may relate to: a request type (e.g., a new ID), the priority level or status of a new request (e.g., a high priority status indicating the importance or urgency of the request), the name or identity of the third party administrator and of the third party, the assigned or relevant (i.e., at issue) system identification information, the date and time of each communication, etc. It is recognized that the attributes may be used to monitor and otherwise track the status of any communication between a third party administrator and the business entity employing or having the workforce member under contract. In one example, the other workforce member-related information is information from a third party administrator transmitted to a business entity regarding the request from the business entity of new system identification information for a workforce member affiliated with the business entity. In another example, the other workforce member-related information relates to a request to cancel or terminate a workforce member's system identification information, or relates to a request for additional access rights for a particular workforce member.

As previously discussed with reference to FIG. 1, in one embodiment, a system operator, such as a human resource employee, may utilize one or more peripheral devices 102 to input system identification information and/or the other workforce member-related information. Similarly, a system operator may be required to enter, e.g., into the one or more peripheral devices 102, one or more credentials identifying the system operator as a person having the necessary access rights to modify, delete or add system identification information for workforce members.

In the embodiment described above, the credentials input by the system operator may be received by security logic 108 via communication logic 116. Security logic 108 is configured to confirm or reject the credentials input by the system operator based on any suitable method or scheme. In one embodiment, security logic 108 is configured to access or otherwise reference a master set of credentials for each potential system operator. In one embodiment, the master set of credentials is stored in the at least one memory 120 and organized as a table. Security logic 108 may access the table and confirm or reject the credentials input by the system operator with the corresponding credentials in the master set of credentials. If the credentials of the system operator are confirmed, the method includes storing the input (e.g., by modification, deletion or addition) of system identification information and/or other workforce member-related information in the at least one memory (e.g., using association and maintenance logic 106). If the credentials are rejected, the system operator is not provided access to the system and may not be permitted to make the association or store such information in the at least one memory. This method of storing the system identification information may be performed using, for example, association logic 106 of FIG. 1 or any other suitable logic.

In one embodiment, the method of block 304 (or any block of FIG. 3) provides for the confirmation of credentials of a particular workforce member to view the system identification information and/or the other workforce member-related information of the particular workforce member and for the display of the same on an associated display device. As is recognized the confirmation of a particular workforce member's credentials to view such information may be performed using, e.g., the security logic 108 and the display of such information may be performed using, e.g., the display logic 112 in the same or similar manner as previously described.

In one embodiment, the method 300 includes block 306, which provides for the association, in the at least one memory, of other human resource information for each workforce member with each such workforce member. Turning to FIG. 1, the association of such human resource information for each workforce member with such workforce member may, in one embodiment be entered using one or more peripheral devices 102 (e.g., by one or more system operators) and stored in the at least one memory 120 in the same or similar manner described above with respected to blocks 204.

Method 300 further includes block 308, which provides for the maintenance, in the at least one memory, of review data associated with a review of the system identification information by the workforce member and corresponding review data by the at least one supervisor. The review data and the corresponding review data indicates whether the system identification information was confirmed or rejected by the respective workforce member and by the at least one supervisor. For example, if the system identification information was deemed to be active, valid or otherwise necessary, the respective workforce member and the at least one supervisor would confirm that the system identification information as active, valid or otherwise necessary. Conversely, the system identification information would be rejected or otherwise determined to be incorrect. It is understood that the criteria “active, valid or otherwise necessary” may be substituted with any other acceptable standard or criteria whether or not in accordance with any policy (such as, for example, an established company policy to be followed by an employee and its supervisor). In one embodiment, method block 308 corresponds to initially storing and maintaining such review data in the at least one memory 120. With reference to FIG. 1, the method of block 308 may, in one embodiment, be performed using association and maintenance logic 106.

In one embodiment, the method of maintaining, in the at least one memory, review data associated with a review of the system identification information by the workforce member includes confirming credentials of a particular workforce member as set forth in block 308 to review the system identification information of the particular workforce member. In one embodiment, this may be performed by security logic 108 in the same or similar manner as described above with respect to the exemplary system operator above. In such an embodiment, method block 308 may also include displaying a list of system identification information associated with the particular workforce member. For example, in the example discussed above, display logic 112 may communicate with or be directed by the association and maintenance logic 106 or may be directed (directly or indirectly) by the one or more peripheral devices 102 to display such a list on the display device 118. In one embodiment, this may require the display logic 112 communicating with the at least one memory 120 to access the appropriate information from the at least one memory 120 using any suitable method or scheme for display on the display device 118.

In the exemplary embodiment discussed above, following the display of the list of system identification information, method block 308 further includes storing, in the at least one memory, the results of a review of the system identification information by the particular workforce member, wherein the results of the review include: a confirmation or rejection of at least a portion of system identification information (e.g., as previously displayed to the particular workforce member using the one or more peripheral devices 102). A rejection of such information may manifest itself in a modification to and/or deletion by the particular workforce member of such information. Upon receipt of the workforce members input (indicating the confirmation or rejection of at least a portion of the system identification information), the input may be stored in the at least one memory using, for example, association and maintenance logic 106 in accordance with any suitable scheme.

In one embodiment, the method of maintaining, in the at least one memory, review data associated with a review of the system identification information by the workforce member includes confirming credentials of a particular supervisor to review system identification information of one or more workforce members for which the particular supervisor is responsible. It is recognized that a particular supervisor may be responsible as a “boss” to one or more workforce members. It is recognized that this method may be performed, in one embodiment, using the security logic 108 and the one or more peripheral devices 102 as described above with respect to the method of confirming credentials of a particular workforce member to review its own system identification information. The method may also include, for example, displaying a list of system identification information associated with one or more workforce members for which the particular supervisor is responsible. For example, the data or information stored in the at least one memory 120 may further associate the particular supervisor with one or more workforce members. In one embodiment, the association may be made in the at least one memory such as memory 120 using association and maintenance logic 106 and may further include associating team or project information for each workforce member and supervisor with each of such workforce member and supervisor, respectively. The team or project information may represent for example at least the name of the team or project for which each workforce member is a part and for which each supervisor is responsible. The display of the list of system identification information on, e.g., display device 118, may be performed in the same or similar manner as described above using the display logic 112 or any other suitable logic. In one embodiment, the display of the list of system identification information may further include displaying, by team or project, the list of system identification information associated with the one or more workforce members that are a part of the team or project.

Thus, the method may allow a particular supervisor to only view (and subsequently review) subcategories of workforce members by team or project. In another embodiment, the display feature described above may include displaying a review status indicator for each team or project based on the results of the review of the system identification information. For example, a default review status indicator may be any graphical widget or text representing that the review for one or more workforce members has not been completed. Upon receipt of a supervisor's review results via, e.g., the one or more peripheral devices 102, the association and maintenance logic 106 may be utilized to associate with the reviewed workforce member's system identification information additional review status information indicating that the review has been completed and, in one embodiment, the results of the review (e.g., a confirmation, a rejection, etc.).

Method 300 may also include block 310 wherein the system identification information is audited by indicating or otherwise recognizing one or more disparities between the review data and the corresponding review data for one or more workforce members. An audit may be requested by any suitable person with the appropriate credentials (e.g., a system operator or supervisor) to generate a report or other information indicating any differences between the review data and corresponding review data of certain workforce members by the workforce members themselves and their respective and responsible supervisors. It is recognized that in one embodiment, the audit may be permitted only after a person's credentials are properly confirmed in accordance with the method of approving credentials using security logic 108 as described above. It is further recognized that in another embodiment, the audit may be processed by or otherwise performed using report logic 114 which is configured to respond to a request for an audit (e.g., from the one or more peripheral devices 102) and to access the respective review data (e.g., stored in the at least one memory 120). In one embodiment, the report logic 114 generates an appropriate report (e.g., as a spreadsheet) and communicates the same information to display logic 112 for appropriate display 118 in accordance with any suitable method or scheme for display to an authorized or other user. It is recognized that the report may also be stored or maintained in the at least one memory 120 for access at a later time, transmitted to another workstation or device, printed, or otherwise used in any necessary manner for a business entity to successfully conduct a suitable audit of system identification information.

In system 200, each of the methods described above with respect to FIG. 3 may be implemented using the one or more processors 202, the at least one memory 120 and the executable instructions 206. For example, the one or more processors 202 may execute the executable instructions 206 to perform the methods as set forth above in the same or similar manner as described with respect to logic components 106-114.

It is recognized that while the method of FIG. 3 does not include specific reference to a graphical user interface (“GUI”) or specific reference to prompts for information on a display device (e.g., display device 118), the method may include the prompting of the users (e.g., the workforce members, the system operators, the supervisors, etc.) for certain information on the one or more peripheral devices 102 using e.g., display logic 112 in accordance with known methods. For example, prior to a system operator inputting or otherwise modifying, deleting or adding system identification information and/or other workforce member-related information, the system operator may be prompted to input the system operator's credentials for confirmation by the security logic 108.

Among other advantages, the above method and apparatus enables a more efficient computer-implemented method for managing system identification information for workforce members. The method and apparatus provides for the tracking of system identification information and other workforce member information from a third party administrator of systems in which workforce members selectively need access. Workforce members and/or other persons with proper credentials may monitor the received and transmitted information. The method and apparatus also provides for the maintenance of review data associated with a review of system identification information by a particular workforce member and corresponding review of system identification information by an associated supervisor. The review data and the corresponding review data indicate whether the particular workforce member and the associated supervisor have confirmed (or, in some instance, rejected) the system identification information associated with the particular workforce member. By maintaining this review data and the corresponding review data in a consolidated and readily obtainable manner, a business entity may conduct its own audit or reduce costs associated with an external audit of system identification information to confirm compliance with any applicable standard, law, regulation or policy.

Other advantages will be recognized by one having ordinary skill in the art. It will also be recognized that the above description describes mere examples and that other embodiments are envisioned and covered by the appended claims. It is therefore contemplated that the present invention cover any and all modifications, variations or equivalents that fall within the spirit and scope of the basic underlying principles disclosed above and claimed herein.

What is claimed is:

1. A computer-implemented method for managing system identification information for workforce members, wherein each workforce member is associated with at least one supervisor, comprising:
associating, in at least one memory, system identification information for each workforce member with each such workforce member, wherein the system identification information represents information capable of being used to access one or more systems managed by a third party administrator; and
maintaining, in the at least one memory, review data associated with a review of the system identification information by the workforce member and corresponding review data by the at least one supervisor, wherein the review data and the corresponding review data indicates whether the system identification information was confirmed by the respective workforce member and by the at least one supervisor.

2. The method of claim 1, wherein associating the system identification information for each workforce member with each such workforce member comprises:
confirming credentials of a system operator to modify, delete or add at least one of: system identification information and other workforce member-related information for one or more workforce members; and
storing at least one of: system identification information and other workforce member-related information entered by the operator in the at least one memory.

3. The method of claim 1, wherein maintaining review data of the system identification information further comprises:
confirming credentials of a particular workforce member to review the system identification information of the particular workforce member;
displaying a list of system identification information associated with the particular workforce member; and
storing, in the at least one memory, the results of the review of the system identification information by the particular workforce member, wherein the results of the review include a confirmation or a rejection of at least a portion of system identification information.

4. The method of claim 1, wherein maintaining corresponding review data of the system identification information further comprises:
confirming credentials of a particular supervisor to review system identification information of one or more workforce members for which the particular supervisor is responsible;
displaying a list of system identification information associated with one or more workforce members for which the particular supervisor is responsible; and
storing, in the at least one memory, the results of the review of the system identification information by the particular supervisor, wherein the results of the review include a confirmation or rejection of at least a portion of system identification information.

5. The method of claim 4, wherein displaying the list of system identification information associated with the one or more workforce members for which the particular supervisor is responsible comprises:
associating, in the at least one memory, team or project information for each workforce member and supervisor with each of such workforce member and supervisor, respectively, wherein the team or project information represents at least the name of the team or project for which each workforce member is a part and for which each supervisor is responsible; and
displaying, by team or project, the list of system identification information associated with the one or more workforce members that are a part of the team or project.

6. The method of claim 5, wherein displaying the list of system identification information associated with the one or more workforce members for which the particular supervisor is responsible further comprises displaying a review status indicator for each team or project based on the results of the review of the system identification information.

7. The method of claim 1, further comprising associating, in the at least one memory, other human resource information for each workforce member with each such workforce member.

8. The method of claim 1, further comprising auditing the system identification information by indicating one or more disparities between the review data and the corresponding review data for one or more workforce members.

9. The method of claim 2, wherein the other workforce member-related information represents information associated with the system identification information that was previously transmitted to or from the third party administrator including at least one of:
priority status;
request type;
third party name;
third party administrator name;
the system identification information;
the date of each communication; and
the time of each communication.

10. The method of claim 9, further comprising:
confirming credentials of a particular workforce member to view at least one of: the system identification information and the other workforce member-related information of the particular workforce member; and
displaying on an associated display device the at least one of: the system identification information and the other workforce member-related information of the particular workforce member.

11. An apparatus for managing system identification information for workforce members, wherein each workforce member is associated with at least one supervisor, comprising:
association logic operative to associate, in at least one memory, system identification information for each workforce member with each such workforce member, wherein the system identification information represents information capable of being used to access one or more systems managed by a third party administrator; and
maintenance logic operative to maintain, in the at least one memory, review data associated with a review of the system identification information by the workforce member and corresponding review data by the at least one supervisor, wherein the review data and the corresponding review data indicates whether the system identification information was confirmed by the respective workforce member and by the at least one supervisor.

12. The apparatus of claim 11, further comprising:
security logic operative to confirm credentials of a system operator to modify, delete or add at least one of: system identification information and other workforce member-related information for one or more workforce members; and
the association logic is operative to store at least one of: the system identification information and other workforce member-related information entered by the operator in the at least one memory.

13. The apparatus of claim 11, further comprising:
security logic operative to confirm credentials of a particular workforce member to review the system identification information of the particular workforce member;
display logic operative to display on an associated display device a list of system identification information associated with the particular workforce member; and
the maintenance logic operative to store, in the at least one memory, the results of the review of the system identification information by the particular workforce member, wherein the results of the review include a confirmation or rejection of at least a portion of system identification information.

14. The apparatus of claim 11, further comprising:
security logic operative to confirm credentials of a particular supervisor to review system identification information of one or more workforce members for which the particular supervisor is responsible;
display logic operative to display on an associated display device a list of system identification information associated with one or more workforce members for which the particular supervisor is responsible; and
the maintenance logic operative to store, in the at least one memory, the results of the review of the system identification information by the particular supervisor, wherein the results of the review include a confirmation or rejection of at least a portion of system identification information.

15. The apparatus of claim 14, wherein:
the association logic is further operative to associate, in the at least one memory, team or project information for each workforce member and supervisor with each of such workforce member and supervisor, respectively, wherein the team or project information represents at least the name of the team or project for which each workforce member is a part and for which each supervisor is responsible, and
the apparatus further comprises display logic operative to display on an associated display device, by team or project, the list of system identification information associated with the one or more workforce members that are a part of the team or project.

16. The apparatus of claim 15, wherein the display logic is operative to display on the associated display device a review status indicator for each team or project based on the results of the review of the system identification information.

17. The apparatus of claim 11, wherein the association logic is further operative to associate, in the at least one memory, other human resource information for each workforce member with each such workforce member.

18. The apparatus of claim 11, further comprising report logic operative to audit the system identification information by generating a report that indicates one or more disparities between the review data and the corresponding review data for one or more workforce members.

19. The apparatus of claim 12, wherein the other workforce member-related information represents information associated with the system identification information that was previously transmitted to or from the third party administrator including at least one of:
priority status;
request type;
third party name;
third party administrator name;
the system identification information;
the date of each communication; and
the time of each communication.

20. The apparatus of claim 19, further comprising:
security logic operative to confirm credentials of a particular workforce member to view at least one of: the system identification information and the other workforce member-related information of the particular workforce member; and
display logic operative to display on an associated display device the at least one of: the system identification information and the other workforce member-related information of the particular workforce member.

21. At least one memory storing executable instructions and operatively coupled to one or more processors, such that when the one or more processors execute the executable instructions, the one or more processors are operative to:
associate, in the at least one memory, system identification information for each workforce member of a plurality of workforce members with each such workforce member, wherein the system identification information represents information capable of being used to access one or more systems managed by a third party administrator and wherein each workforce member is associated with at least one supervisor; and
maintain, in the at least one memory, review data associated with a review of the system identification information by the workforce member and corresponding review data by the at least one supervisor, wherein the review data and the corresponding review data indicates whether the system identification information was confirmed by the respective workforce member and by the at least one supervisor.

22. The at least one memory of claim 21, wherein the one or more processors are further operative to associate the system identification information for each workforce member with each such workforce member by:
confirming credentials of a system operator to modify, delete or add at least one of: system identification information and other workforce member-related information for one or more workforce members; and
storing at least one of: system identification information and other workforce member-related information entered by the operator in the at least one memory.

23. The at least one memory of claim 21, wherein the one or more processors are operative to maintain review data of the system identification information by:
confirming credentials of a particular workforce member to review the system identification information of the particular workforce member;
displaying on an associated display device a list of system identification information associated with the particular workforce member; and
storing, in the at least one memory, the results of the review of the system identification information by the particular workforce member, wherein the results of the review include a confirmation or rejection of at least a portion of system identification information.

24. The at least one memory of claim 21, wherein the one or more processors are operative to maintain corresponding review data of the system identification information by:
confirming credentials of a particular supervisor to review system identification information of one or more workforce members for which the particular supervisor is responsible;
displaying on an associated display device a list of system identification information associated with one or more workforce members for which the particular supervisor is responsible; and
storing, in the at least one memory, the results of the review of the system identification information by the particular supervisor, wherein the results of the review include a confirmation or rejection of at least a portion of system identification information.

25. The at least one memory of claim 24, wherein the one or more processors are operative to display the list of system identification information associated with the one or more workforce members for which the particular supervisor is responsible by:
associating, in the at least one memory, team or project information for each workforce member and supervisor with each of such workforce member and supervisor, respectively, wherein the team or project information represents at least the name of the team or project for which each workforce member is a part and for which each supervisor is responsible; and
displaying on an associated display device, by team or project, the list of system identification information associated with the one or more workforce members that are a part of the team or project.

26. The at least one memory of claim 25, wherein the one or more processors are further operative to display on the display device a review status indicator for each team or project based on the results of the review of the system identification information.

27. The at least one memory of claim 21, wherein the one or more processors are further operative to associate, in the at least one memory, other human resource information for each workforce member with each such workforce member.

28. The at least one memory of claim 21, wherein the one or more processors are further operative to audit the system identification information by indicating one or more disparities between the review data and the corresponding review data for one or more workforce members.

29. The at least one memory of claim 22, wherein the other workforce member-related information represents information associated with the system identification information that was previously transmitted to or from the third party administrator including at least one of:
priority status;
request type;
third party name;
third party administrator name;
the system identification information;
the date of each communication; and
the time of each communication.

30. The at least one memory of claim 29, wherein the one or more processors are further operative to:
confirm credentials of a particular workforce member to view at least one of: the system identification information and the other workforce member-related information of the particular workforce member; and
display on an associated display device the at least one of: the system identification information and the other workforce member-related information of the particular workforce member.
